(19) United States
(12) Patent Application Publication
(10) Pub. No.: US 2015/0324541 A1
(43) Pub. Date: Nov. 12, 2015

(54) HEALTH MONITORING SYSTEM FOR CALCULATING A TOTAL RISK SCORE

(71) Applicant: KONINKLIJKE PHILIPS N.V., EINDHOVEN (NL)

(72) Inventors: Amy Oi Mee CHEUNG, EINDHOVEN (NL); Maryam ATAKHORRAMI, CAMBRIDGE (GB); Choo Chiap CHIAU, SHANGHAI (CN); David Paul WALKER, CAMBRIDGE (GB); Tamara Mathea Elisabeth NIJSEN, WEERT (NL); Rebecca TSAO, CAMBRIDGE (GB)

(21) Appl. No.: 14/360,691

(22) PCT Filed: Nov. 23, 2012
(86) PCT No.: PCT/IB2012/056686

§ 371 Date: May 27, 2014

Related U.S. Application Data
(60) Provisional application No. 61/563,934, filed on Nov. 28, 2011.

(51) Int. Cl. G06F 19/00

(52) U.S. Cl. CPC G06F 19/3431

(57) ABSTRACT

Embodiments of the invention provide for a health monitoring system comprising an activity monitor. The health monitoring system further comprises a processor and a memory for storing machine readable instructions. The instructions cause the processor to derive activity counts from the activity data acquired by the activity monitor. The instructions further cause the processor to store the activity counts in the memory, and are associated with a time. The instructions further cause the processor to calculate at least two statistical parameters from the activity counts, wherein the at least two statistical parameters are descriptive of the activity counts as a function of time. The instructions further causes the processor to calculate a risk score for each of the at least two statistical parameters. The instructions further cause the processor to calculate a total risk score using the risk score for each of the at least two statistical parameters.

### TECHNICAL FIELD

The invention relates to the monitoring of the activity of a subject, in particular, for calculating a total risk score using the time dependent activity of the subject.

### BACKGROUND OF THE INVENTION

Hospitalizations caused by acute COPD exacerbations have a negative impact on disease progression. Patients who are frequently readmitted suffer a lower health-related quality of life. Furthermore, hospitalizations are the main determinant of the overall health care expenditure for patients with COPD. After hospitalization, many patients are readmitted within 3 months, many of which could have been avoided.

By understanding the risk of a patient for developing an acute exacerbation, appropriate intervention can be provided on time to ensure that the patient avoids hospitalization.

United States patent application US 2011/0125044 A1 discloses an automated system for monitoring respiratory diseases. Accelerometer signals are analyzed to determine activity levels. Analyses of a user's symptoms and activity level prior to, during, and after an event can provide meaningful determinations of disease severity and predict future respiratory disease.

### SUMMARY OF THE INVENTION

The invention provides for a health monitoring system, a computer program product, and a method of health monitoring in the independent claims. Embodiments are given in the dependent claims.

Embodiments of the invention may provide a method for determining the risk of a patient for an acute exacerbation and re-hospitalization. The method includes combining a variety of information extracted from the activity data, including general activity counts, time spent walking and sitting or lying, walking patterns and step counts and respiration data, such as respiration rate and respiration recovery time. A risk score is then derived to indicate the risk of the patient for acute exacerbation and re-hospitalization.

Chronic Obstructive Pulmonary Disease (COPD) related hospitalizations are a result of acute exacerbations, which significantly decrease the health related quality of life of COPD patients. A high frequency of acute exacerbations is linked to a poor prognosis for survival.

Approximately one third of the patients who are hospitalized are subsequently readmitted within 3 months. However many of these readmissions could potentially have been avoided if clinicians were more aware of the risk of the patient for readmission. Therefore, knowing which patients are more susceptible to developing an acute exacerbation can enable clinicians to intervene in a timely manner, before patients reach the acute stage of an exacerbation, and thus avoid hospitalization.

Embodiments of the invention may provide a method to assess the risk of a patient for developing an acute exacerbation and hospital readmission. Analyzing data collected from an accelerometer or in combination with a respiration sensor can provide valuable information relating to the condition of the patient. For example, if the patient begins to spend an increasing amount of time sitting or lying down, walking less, taking more pauses than normal and/or having an increased respiration relaxation rate, then there is indication that the patient's health status is deteriorating. By examining specific details of the patient activity and respiration patterns, it is possible to generate a risk score to indicate the likelihood of the patient for an acute exacerbation and hospital readmission. The risk score is then converted to a 3 level risk assessment: high, medium or low risk, which is a simple analysis of risk for clinicians to understand and act upon. Consequently, appropriate intervention can be provided to ensure that the patient does not deteriorate to the stage where they require hospital treatment.

A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device. Examples of computer-readable storage media include, but are not limited to: a floppy disk, punched tape, punch cards, a magnetic hard disk drive, a solid state hard disk, flash memory, a USB thumb drive, Random Access Memory (RAM), Read Only Memory (ROM), an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example a data may be retrieved over a modem, over the internet, or over a local area network. References to a computer-readable storage medium should be interpreted as possibly being multiple computer-readable storage mediums. Various executable components of a program or programs may be stored in different locations. The computer-readable storage medium may for instance be multiple computer-readable storage medium within the same computer system. The computer-readable storage medium may also be computer-readable storage medium distributed amongst multiple computer systems or computing devices.

‘Computer memory’ or ‘memory’ is an example of a computer-readable storage medium. Computer memory is any memory which is directly accessible to a processor. Examples of computer memory include, but are not limited to: RAM memory, registers, and register files. References to ‘computer memory’ or ‘memory’ should be interpreted as possibly being multiple memories. The memory may for instance be multiple memories within the same computer system. The memory may also be multiple memories distributed amongst multiple computer systems or computing devices.

‘Computer storage’ or ‘storage’ is an example of a computer-readable storage medium. Computer storage is any non-volatile computer-readable storage medium. Examples of computer storage include, but are not limited to: a hard disk drive, a USB thumb drive, a floppy drive, a smart card, a DVD, a CD-ROM, and a solid state hard drive. In some embodiments computer storage may also be computer memory or vice versa. References to ‘computer storage’ or ‘storage’ should be interpreted as possibly being multiple storage. The storage may for instance be multiple storage devices within the same computer system or computing device. The storage may also be multiple storages distributed amongst multiple computer systems or computing devices.

A ‘processor’ as used herein encompasses an electronic component which is able to execute a program or machine executable instruction. References to the computing device comprising ‘a processor’ should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. Many programs have their instructions performed by multiple processors that may be within the same computing device or which may even be distributed across multiple computing devices.

A ‘user interface’ as used herein is an interface which allows a user or operator to interact with a computer or computer system. A ‘user interface’ may also be referred to as a ‘human interface device.’ A user interface may provide information or data to the operator and/or receive information or data from the operator. A user interface may enable input from an operator to be received by the computer and may provide output to the user from the computer. In other words, the user interface may allow an operator to control or manipulate a computer and the interface may allow the computer indicate the effects of the operator's control or manipulation. The display of data or information on a display or a graphical user interface is an example of providing information to an operator. The receiving of data through a keyboard, mouse, trackball, touchpad, pointing stick, graphics tablet, joystick, gamepad, webcam, headset, gear sticks, steering wheel, pedals, wired glove, dance pad, remote control, one or more switches, one or more buttons, and accelerometer are all examples of user interface components which enable the receiving of information or data from an operator.

A ‘hardware interface’ as used herein encompasses a interface which enables the processor of a computer system to interact with and/or control an external computing device and/or apparatus. A hardware interface may allow a processor to send control signals or instructions to an external computing device and/or apparatus. A hardware interface may also enable a processor to exchange data with an external computing device and/or apparatus. Examples of a hardware interface include, but are not limited to: a universal serial bus, IEEE 1394 port, parallel port, IEEE 1284 port, serial port, RS-232 port, IEEE-488 port, Bluetooth connection, Wireless local area network connection, TCP/IP connection, Ethernet connection, control voltage interface, MIDI interface, analog input interface, and digital input interface.

A ‘display’ or ‘display device’ as used herein encompasses an output device or a user interface adapted for displaying images or data. A display may output visual, audio, and or tactile data. Examples of a display include, but are not limited to: a computer monitor, a television screen, a touch screen, tactile electronic display, Braille screen, Cathode ray tube (CRT), Storage tube, Bistable display, Electronic paper, Vector display, Flat panel display, Vacuum fluorescent display (VF), Light-emitting diode (LED) displays, Electroluminescent display (ELD), Plasma display panels (PDP), Liquid crystal display (LCD), Organic light-emitting diode displays (OLED), a projector, and Head-mounted display.

In one aspect the invention provides for a health monitoring system comprising an activity monitor for acquiring activity data descriptive of the time-dependent motion of a subject. The time-dependent motion of the subject may be internal and/or external motion. An example of external motion may be motion caused by the subject walking or running. An example of internal motion may be the breathing of a subject. For instance an activity monitor worn by a subject may detect motions or change in motion due to the subject moving and/or breathing. The health monitoring system further comprises a processor for controlling the health monitoring system. The processor may be interpreted as being multiple processors and may also be located at different locations. The health monitoring system further comprises a memory for storing machine-readable instructions.

Execution of the instructions cause the processor to derive activity counts from the activity data. An activity count as used herein is a discreet measure of activity derived from the activity data. For instance, as a subject moves about a room or performs some action an accelerometer will record repeated accelerations. A certain amount of activity may be used to register as an activity count. Execution of the instructions further cause the processor to store the activity counts in the memory. Each of the activity counts is associated with a time. In other words the time-dependent activity counts are stored in the memory.

Execution of the instructions further cause the processor to calculate at least two statistical parameters from the activity counts. The at least two statistical parameters are descriptive of the activity counts as a function of time. Execution of the instructions further causes the processor to calculate a risk score for each of the at least two statistical parameters. Each of the at least two statistical parameters may be associated with a risk for the subject. Execution of the instructions further causes the processor to calculate a total risk using the risk scores for each of the at least two statistical parameters. Embodiments of the invention may be beneficial because the calculation of a total risk from the at least two statistical parameters enables the detection of changes in the activity level of a subject. This may enable the accurate planning of when the subject should be re-examined or re-hospitalized.

In another embodiment the activity monitor comprises an accelerometer for measuring accelerometer data. The activity data comprises accelerometer data. Execution of the instructions cause the processor to derive activity counts from the accelerometer data. The accelerometer may be used for measuring the acceleration of the subject. Such accelerations may be indicative that the subject is moving or engaging in physical activity.

In another embodiment execution of the instructions further cause the processor to band-pass filter the accelerometer data. This band-passing of the filter may be performed digitally or may be performed using an analogue circuit. Execution of the instructions further causes the processor to identify peaks in the band-pass filtered accelerometer data. Execution of the instructions further cause the processor to classify each of the peaks as either a stride or half-stride in accordance with the amplitude to calculate a third time-dependent speed, elapsed time from a previous step, and an estimated walking speed. At least one of the two statistical parameters is descriptive of the time-dependent walking speed. This embodiment may be advantageous because it may more accurately identify the number of steps or strides that a subject has taken. This may lead to a more accurate determination of the activity counts.

In another embodiment the peaks are classified by comparing the peak amplitude, the elapsed time from a previous step, and the estimated walking speed to a predetermined paragraph space. Essentially a parameter space which contains and mentions the peak amplitude, the elapsed time from the previous step and the estimated walking speed may be used to define a three-dimensional parameter space. Through empirical experiments the parameter space can be divided into two regions, the stride or a half-stride. After the peak amplitude, the elapsed time from the previous step and the estimated walking speed are determined the value list can be checked against the predetermined parameter space and a determination if it is a stride or half-stride may be made. The predetermined parameter space may be for a particular subject or it may be for a group or assemble of subjects. This embodiment may be advantageous because it provides an accurate way of classifying a step detected by an accelerometer as either a stride or a half-stride.

In another embodiment the activity monitor comprises a respiration sensor for measuring respiration data descriptive of the respiration rate of the subject. A respiration sensor as used herein encompasses a sensor which may be used for measuring the respiration rate of the subject. This may be performed in a variety of ways. For instance an accelerometer, a microphone and a chest expansion sensor may be used. The activity data comprises the respiration data. This may be because the accelerometer measures both the internal and external motion of the subject.

In another embodiment a different type of respiration data is acquired and is simply attached to or included in the activity data. The activity data comprises the respiration data. Execution of the instructions further causes the processor to calculate respiration rate data from the respiration data. Execution of the instructions further causes the processor to store the respiration rate data in the memory. The respiration rate data is associated with a time. The respiration rate data is therefore time-dependent. This may be advantageous because the activity counts as stored in the memory are also time-dependent. Therefore the time-dependent activity counts may be compared directly with the time-dependent respiration rate data. Execution of the instructions further causes the processor to calculate at least one additional statistical parameter from the respiration rate data.

Execution of the instructions further cause the processor to calculate an additional risk score for the at least one additional statistical parameter. The total risk score is calculated at least partially using the additional risk score. This embodiment may be advantageous because the rate of respiration and the activity of the subject may be compared. For instance after activity it may be noted what the respiration rate is and also how long it takes for the subject to recover. This may be a very efficient measurement of the fitness of the subject.

In another embodiment the at least one additional statistical parameter is calculated using the activity counts to determine a respiration recovery rate. The respiratory health of a subject is very dependent upon how quickly the subject can recover after strenuous exercise. A respiration recovery rate as used herein is a measure or rate calculated which is indicative of how long it takes the cardiovascular system of a subject to recover after exercise. The at least one additional statistical parameter may be calculated using a combination of the time dependent respiration recovery rate and the time dependent activity counts.

In another embodiment the respiration sensor is an accelerometer.

In another embodiment the respiration sensor is a microphone.

In another embodiment the respiration sensor is a chest expansion sensor.

In another embodiment execution of the instructions further causes the processor to calculate at least one behavioral parameter from the activity counts. The behavioral parameter is descriptive of the activity counts as a function of time. For instance the activity counts may be used to determine the type of behavior the subject is engaged in. For instance the time-distribution of activity counts when the subject is asleep or performing some other activity may be determined. Execution of the instructions further cause the processor to calculate a behavioral similarity score for the at least one behavioral parameter. For instance prior activity of the subject may be monitored and the change in the behavioral parameter may be studied. For instance the length of time or the time in which a subject awakes from sleeping may be monitored as a behavioral parameter.

A baseline value for the at least one behavioral parameter may be established for a duration of time. In some embodiments the behavioral similarity score is a change or deviation of the behavioral parameter from previous value or values. This may be particularly beneficial in monitoring changes in the subject's behavior. For instance the total activity counts that a subject may have may be the same in one day or within a sequence of days, however the behavior of the subject has changed radically.

In another embodiment the multiple behavior parameters are calculated using the activity counts. The multiple behavior parameters comprise the at least one behavioral parameter. A behavioral similarity score is calculated for each of the multiple behavior parameters. Execution of the instructions further causes the processor to calculate a total behavioral similarity score for each of the at least two statistical parameters.

In another embodiment the total risk score is calculated at least partially using the total behavioral similarity score.

In another embodiment the at least one behavioral parameter is a classification of activity intensity according to time of the day.

In another embodiment the at least one behavioral parameter is the longest of period of time where the activity counts are above a predetermined activity level.

In another embodiment the at least one behavioral parameter is the time of day of the longest period of time where the activity counts are above a predetermined activity level.

In another embodiment the at least one behavioral parameter is the waking time.

In another embodiment the at least one behavioral parameter is the sleeping time of the subject.

In another embodiment the at least one behavioral parameter is the sleep duration.

In another embodiment the at least one behavioral parameter is the total activity counts during sleep.

In another embodiment the at least one behavioral parameter is the longest period of time where the activity counts are below a predetermined activity level.

In another embodiment the at least one behavioral parameter is the time of day of the longest period of time where the activity counts are below a predetermined activity level.

In another embodiment the at least one behavioral parameter is the time of the longest sustained activity.

In another embodiment the at least one behavioral parameter is the intensity level of the longest sustained activity.

In another embodiment the at least one behavioral parameter is the duration of the longest sustained activity.

In another embodiment the at least one behavioral parameter is the time of the longest sustained inactivity.

In another embodiment the at least one behavioral parameter is the duration of the longest sustained inactivity.

In another embodiment the at least one behavioral parameter is the average activity counts during different intervals of the day.

In another embodiment the at least one behavioral parameter are the pauses during walking.

In another embodiment the at least one behavioral parameter is the duration of pauses.

In another embodiment the at least one behavioral parameter is the time spent sitting.

In another embodiment the at least one behavioral parameter is the time spent lying.

In another embodiment the at least one behavioral parameter is the time spent walking.

In another embodiment the at least one behavioral parameter is the transition times between activities.

In another embodiment the at least one behavioral parameter are combinations of the aforementioned behavioral patterns.

In another embodiment execution of the instructions cause the processor to calculate an activity template from archived activity counts. The at least one behavioral parameter is calculated making a comparison of the activity counts to the daily activity template. The archived activity counts may be time-dependent activity counts that have been stored in the memory over a predetermined period of time. The daily activity template may record such things as when the subject wakes up and goes to sleep. They may also contain information about the average amount of time the subject spends moving. This may be beneficial because comparisons to the activity template may indicate rapid changes in the subject's behavior which may require the attention of a physician or healthcare provider.

In another embodiment the activity template is any one of the following: a monthly activity template, a weekly activity template, a daily activity template, exercise activity template, and a rest day activity template. A monthly activity template may for instance be an average of the subject's activity over a month as a function of time. Likewise a weekly activity template and a daily activity template may be the average activity over a week and day respectively. The exercise activity template may be an activity template taken from a day when the subject performs exercise. The rest day activity template may be taken from day or days when the subject rests or does not exercise. This embodiment may be beneficial because it provides different time scales upon which the activity of the subject can be compared.

In another embodiment the daily template is calculated by binning and averaging the archived activity counts in a predetermined number of daily time bins. The comparison of the activity counts to the daily activity template is performed by binning the activity counts into the daily time bins. The comparison is further performed by comparing the number of the activity counts in each of the daily time bins to the average number of archived activity counts in each of the daily time bins.

In another embodiment the at least one behavioral parameter is one of the at least two statistical parameters. Essentially in some embodiments a behavioral parameter may be the same as a statistical parameter.

In another embodiment the at least two statistical parameters comprise any one of the following: the total activity counts per day, average activity counts per day, the peak activity counts per day, the longest period of activity counts above a predetermined threshold, the longest period of activity counts below a predetermined threshold, an activity transition duration, and combinations thereof. An activity transition duration may for instance be the time it takes for a subject to change types of activity: for instance, going between sleeping and waking. An example of an activity transition duration would be waking up and getting out of bed.

In another embodiment execution of the instructions further causes the processor to perform any one of the following: display the total risk score on a display, forward the total risk score to a remote patient management system, email the total risk score, and combinations thereof. This embodiment may be beneficial because the total risk score on a display may provide feedback to a subject on his or her behavior. Additionally forwarding a total risk score to a remote patient management system or emailing it may provide the information to a physician. A remote patient management system as used herein is a system which may collect data from subject input and/or sensor data and is used to provide healthcare information to the subject or patient.

In another embodiment the activity counts are stored in memory by binning them into time intervals.

In another aspect the invention provides for a computer program product comprising machine-executable instructions for execution of a processor of a health monitoring system. The health system comprises an activity monitor for acquiring activity data descriptive of the time-dependent motion of a subject. Execution of the instructions causes the processor to drive activity counts from the activity data. Execution of the instructions further causes the processor to store the activity counts in the memory. Each of the activity counts is associated with the time. Execution of the instructions further causes the processor to calculate at least two statistical parameters from the activity counts. The at least two statistical parameters are descriptive of the activity counts as a function of time. Execution of the instructions further causes the processor to calculate a risk score for each of the at least two statistical parameters. Execution of the instructions further causes the processor to calculate a total risk score using the risk score for each of the at least two statistical parameters.

In another aspect the invention provides for a method of health monitoring. The method comprises the step of deriving activity counts from the activity data of an activity monitor. The activity monitor is operable for acquiring activity data descriptive of the time-dependent motion of a subject. For instance activity above a certain threshold for a particular period of time may count as an activity count. In other embodiments the activity of the subject is integrated over time and converted into activity counts. The activity for instance may be a measure of the acceleration that the subject experiences over a period of time. The method further comprises the step of recording the activity counts. Each of the activity counts is associated with a time. The method further comprises the step of calculate at least two statistical parameters from the activity counts. The at least two statistical parameters are descriptive of the activity counts as a function of time. The method further comprises the step of calculating a risk score for each of the at least two statistical parameters. The method further comprises the step of calculating a total risk score using the risk score for each of the at least two statistical parameters.

In another embodiment the method further comprises the step of determining a risk stratification using the total risk score.

In another embodiment the method further comprises the step of calculating a risk classification for chronic obstructive pulmonary disease or COPD exacerbation.

In another embodiment the method further comprises the step of hospitalizing the subject if the total risk score is within or above a predetermined range.

### BRIEF DESCRIPTION OF THE DRAWINGS

In the following preferred embodiments of the invention will be described, by way of example only, and with reference to the drawings in which:

FIG. 1 shows a flow diagram which illustrates a method according to an embodiment of the invention;

FIG. 2 shows a flow diagram which illustrates a method according to a further embodiment of the invention;

FIG. 3 shows a flow diagram which illustrates a method according to a further embodiment of the invention;

FIG. 4 illustrates a health monitoring system according to a further embodiment of the invention;

FIG. 5 illustrates a health monitoring system according to an embodiment of the invention;

FIG. 6 shows a flow diagram which illustrates a method according a further embodiment of the invention;

FIG. 7 shows a plot of time 700 versus activity counts;

FIG. 8 shows a plot of the time versus the respiration rate;

FIG. 9 shows a table which illustrates how a health condition index can be assigned using the recovery time calculated in FIG. 8;

FIG. 10 shows a table which illustrates how to calculate a total risk score.

FIG. 11 shows an example of activity patterns in COPD patients;

FIG. 12 shows the total number of activity counts per day is shown;

FIG. 13 shows the same data as shown in FIG. 12 except that the amount of time spent in different types of activity is shown;

FIG. 14 shows a plot of the maximum activity duration for different days;

FIG. 15 shows an activity diagram for multiple days;

FIG. 16 shows the same data for the average activity count in intervals during the day and the evening;

FIG. 17 shows a table which illustrates the calculation of the total behavioral similarity score;

FIG. 18 shows an accelerometer signal acquired by an activity monitor;

FIG. 19 shows another accelerometer signal acquired by an activity monitor; and

FIG. 20 shows an example of how detected steps can be classified.

### DETAILED DESCRIPTION OF THE EMBODIMENTS

Like numbered elements in these figures are either equivalent elements or perform the same function. Elements which have been discussed previously will not necessarily be discussed in later figures if the function is equivalent.

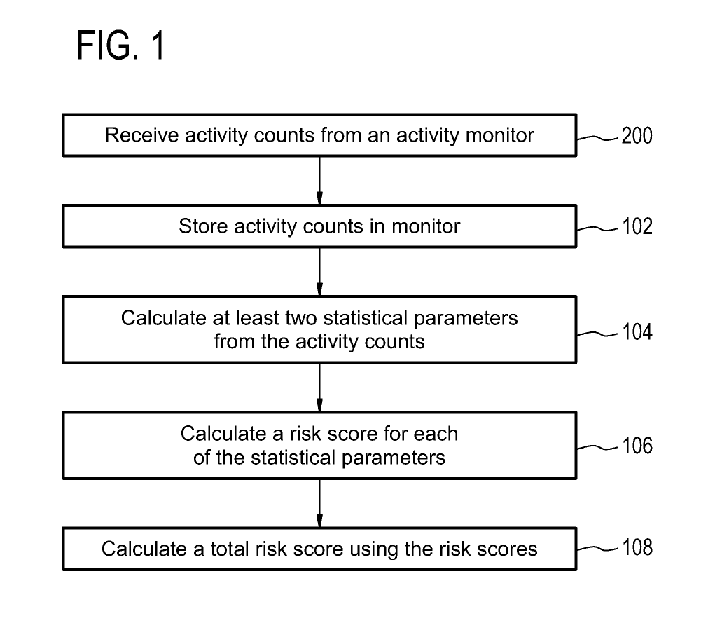

FIG. 1 shows a flow diagram which illustrates a method according to an embodiment of the invention. In step 100 activity counts are received from an activity monitor. Next in step 102 the activity counts are stored in memory. The activity counts are either stored in such a way to associate them with a time. For instance activity counts may have individual time stamps or they may be placed into bins which indicate a time range. Next in step 104 at least two statistical parameters are calculated from the activity counts. The statistical parameters use the time relationship of the activity counts. Next in step 106 a risk score is calculated for each of the statistical parameters. Then finally in step 108 a total risk score is calculated using the risk scores for each of the statistical parameters.

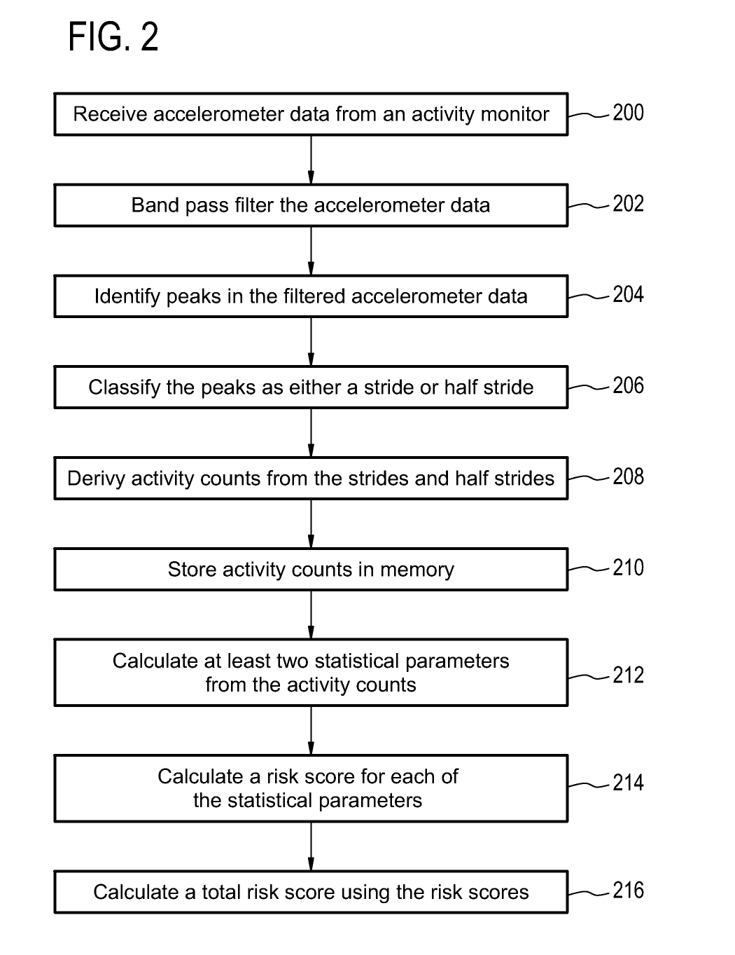

FIG. 2 shows a flow diagram of a method according to a further embodiment of the invention. In step 200 accelerometer data is received from an activity monitor. Next in step 202 the accelerometer data is band-passed. The band-pass may be performed by a digital filter. Next in step 204 peaks in the filtered accelerometer data are identified. Next in step 206 the peaks are either classified as a stride or a half-stride. Next in step 208 activity counts are derived from the strides and half-strides. For instance an activity count may be equal to a certain number of strides or half-strides. Next in step 210 the activity counts are stored in memory. The activity counts are stored in such a fashion that each of the activity counts is associated with a time or a time range. Next in step 212 at least two statistical parameters are calculated from the activity counts. In step 214 a risk score is calculated for each of the statistical parameters. Finally in step 216 a total risk score is calculated using the risk scores.

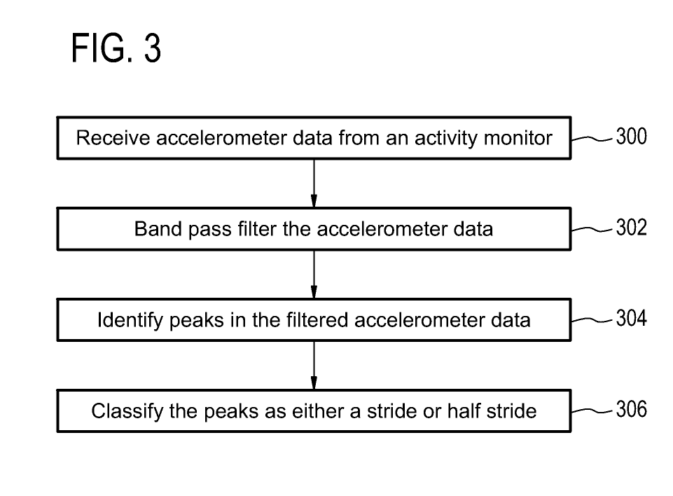

FIG. 3 shows a flow diagram according to a further embodiment of the invention. In step 300 accelerometer data is received from an activity monitor. Next in step 302 the accelerometer data is band-pass filtered. Next in step 304 peaks in the filtered accelerometer data are identified. And finally in step 306 the peaks are classified as either a stride or a half-stride.

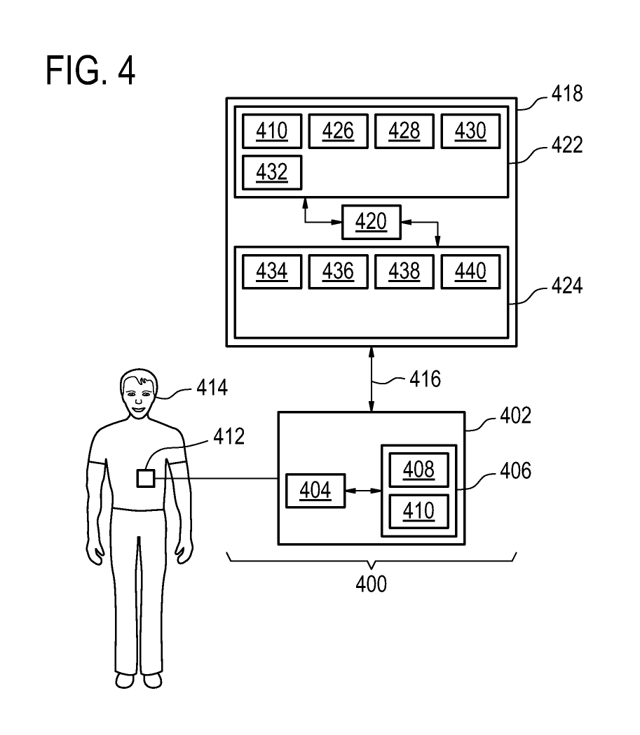

FIG. 4 illustrates a health monitoring system 400 according to an embodiment of the invention. In this Fig. an activity monitor 402 is shown. The activity monitor 402 comprises a processor 404 and a memory 406. The processor 404 is connected to the memory for executing a program 408 which is stored in the memory 406. The program 408 contains computer-executable code for operating and the functioning of the activity monitor 402. The memory 406 also contains activity data 410 which has been acquired from a sensor 412 in proximity of the subject 414. In some embodiments the entire activity monitor 402 is worn by the subject 414. The sensor 412 may be an accelerometer or other sensor which is able to detect the motion of the subject 414. The sensor 412 may also comprise a microphone for detecting respiration or a chest expansion sensor also for detecting the respiration of the subject 414.

The activity monitor 402 is connected by a network connection 416 to a computer 418. The computer 418 comprises a processor 420 which is connected to computer storage 422 and computer memory 424. Within the computer storage 422 there is shown activity data 410 which the computer 418 has received from the activity monitor 402. The computer storage 422 is further shown as containing activity counts 426. The computer storage 422 is further shown as containing statistical parameters 428 which have been calculated from the activity counts 426. The computer storage 422 is further shown as containing risk scores 430. The risk scores 430 have been calculated from the statistical parameters 428. The computer memory 422 is further shown as containing a total risk score 432 which has been calculated from the risk scores 430.

The computer memory 424 is shown as containing an activity count calculation module 434. The activity count calculation module 434 contains computer-executable code which enables the processor 420 to calculate the activity counts 426 from the activity data 410. The computer memory 424 is further shown as containing a statistical parameter calculation module 436. The statistical parameter calculation module 436 contains computer-executable code which enables the processor 420 to calculate the statistical parameters 428 from the activity counts 426. The computer memory 424 is further shown as containing a risk score calculation module 438. The risk score calculation module 438 contains computer-executable code which enables the processor 420 to calculate risk scores 430 from the statistical parameters 428. The computer memory 424 is further shown as containing a total risk score calculation module 440. The total risk score calculation module 440 contains computer-executable code which enables the processor 420 to calculate the total risk score 432 using the risk scores 430.

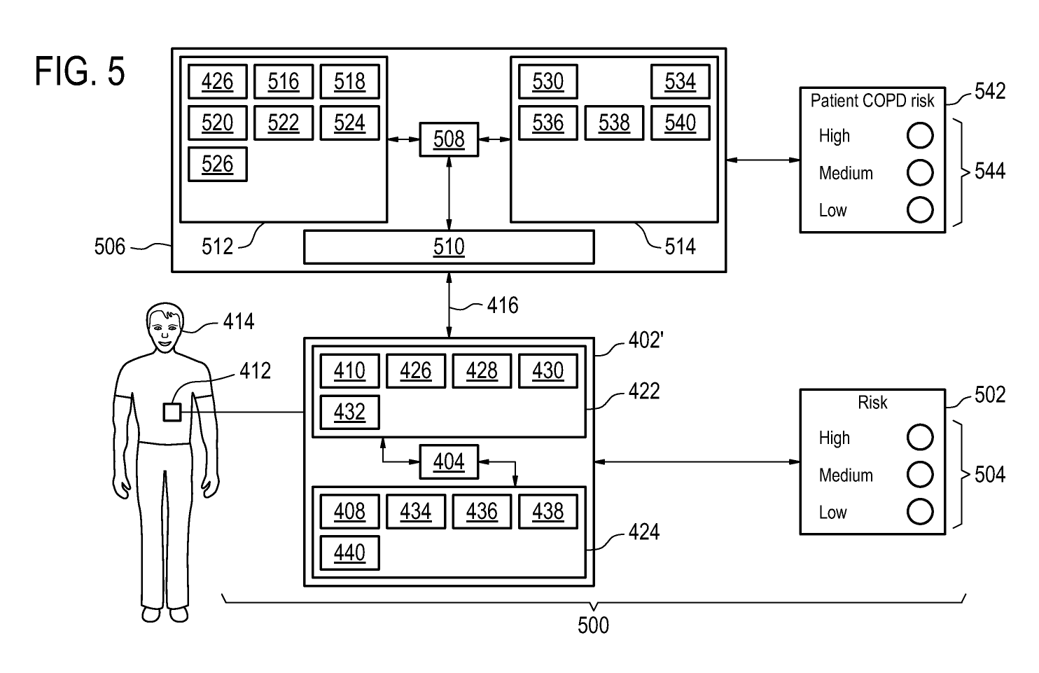

FIG. 5 shows a health monitoring system 500 according to a further embodiment of the invention. In this embodiment there is an activity monitor 402′. The activity monitor 402′ combines the functionality of the activity monitor 402 and the computer 418 of FIG. 4. This is one illustration of how the functionality of the health monitoring system can be distributed across different processors.

The activity monitor 402 has a display 502. On the display 502 there are risk feedback indicators 504 able to indicate the total risk score 432 to the subject 414. The display 502 could be a graphical display such as an LCD or OLED display or it can simply be indicators such as light-emitting diodes to indicate high, medium and low risk.

The activity monitor 402 communicates to a computer 506 via network connection 416. The computer 506 comprises a processor 508 which is connected to a user interface 510, computer, computer storage 512 and computer memory 514. Computer storage 512 is shown as containing activity counts 426 which were received from the activity monitor 402′. The computer storage 512 is further shown as containing a behavioral parameter 516 calculated from the activity counts 426. The computer storage 512 is further shown as containing a behavioral similarity score 518 calculated from the behavioral parameters 516. The computer storage 512 is further shown as containing a total behavioral similarity score 520 calculated from the behavioral similarity scores 518. The computer storage 512 is further shown as containing an activity count database 522. The activity count database 522 contains archived activity counts acquired by the activity monitor 402. The computer storage 512 is further shown as containing an activity template 524 derived from the activity count database 522. The computer storage 512 is further shown as containing a risk stratification 526 calculated from the activity template 524.

The computer memory 514 is further shown as containing a behavioral parameter calculation module 530. The behavioral parameter calculation module 530 contains computer-executable code which enables the processor 508 to calculate the behavioral parameter 516 from the activity counts 426. The computer memory 514 is further shown as containing a behavioral similarity score calculation module 532. The behavioral similarity score calculation module 532 contains computer-executable code which enables the processor 508 to calculate the behavioral similarity scores 518 from the behavioral parameter 516.

The computer memory 514 further contains a total behavioral similarity score calculation module 534. The total behavioral similarity score calculation module 534 contains computer-executable code for calculating the total behavioral similarity score 520 from the behavioral similarity score 518. The computer memory 514 is further shown as containing a risk stratification calculation module 538. The risk stratification calculation module 538 contains computer-executable code which calculates the risk stratification 526 using the activity template and/or the total behavioral similarity score 520.

The computer storage 514 is shown as further containing an activity count analysis module 536 which contains computer-executable code which enables the processor 508 to calculate the activity template 524 from the activity count database 522. The computer memory 514 is shown as further having a patient management module 540 which enables a physician or healthcare provider to view a graphical user interface 524. The graphical user interface in this case shows a risk stratification 526 which is indicated as a risk stratification indication 544 on the graphical user interface 542.

Embodiments of the invention may provide a method to assess the risk of a patient for developing an acute exacerbation and hospital readmission. Analyzing data collected from an accelerometer or in combination with a respiration sensor can provide valuable information relating to the condition of the patient. For example, if the patient begins to spend an increasing amount of time sitting or lying down, walking less, taking more pauses than normal and/or having an increased respiration relaxation rate, then there is indication that the patient's health status is deteriorating. By examining specific details of the patient activity and respiration patterns, it is possible to generate a risk score to indicate the likelihood of the patient for an acute exacerbation and hospital readmission. The risk score is then converted to a 3 level risk assessment: high, medium or low risk, which is a simple analysis of risk for clinicians to understand and act upon. Consequently, appropriate intervention can be provided to ensure that the patient does not deteriorate to the stage where they require hospital treatment.

The invention may comprise an accelerometer, which is used to collect activity and respiration data after the patient has been discharged from hospital. Alternatively, a respiration sensor can be used to obtain respiration data. The accelerometer measures continuous data from the patient. The data is analyzed to provide various types of information related to activity and respiration, described below.

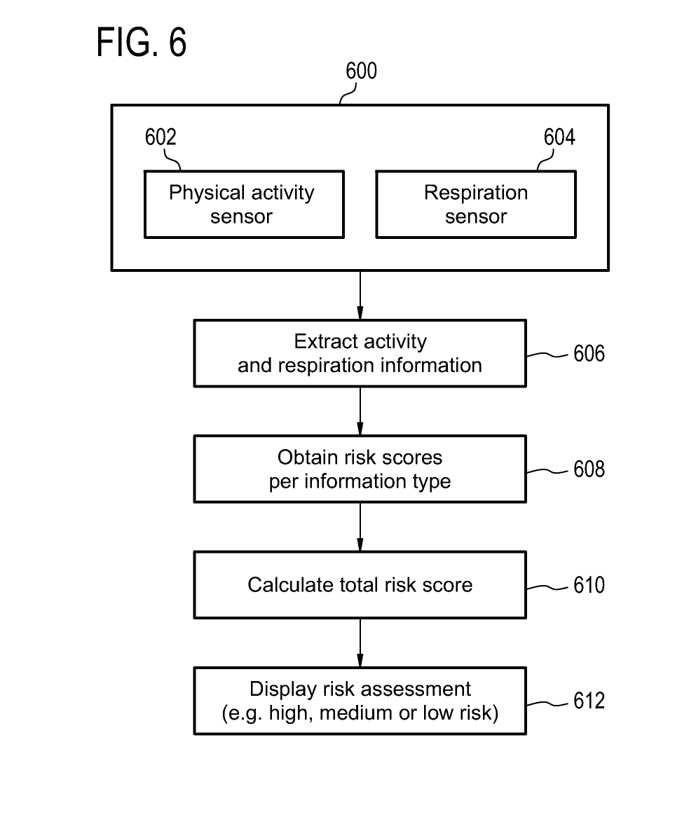

FIG. 6 shows a flow diagram which illustrates a method according an embodiment of the invention. In step 600 sensor data is acquired. This may include in some embodiments physical activity sensor data 602 and respiration sensor data 604. Next in step 606 the activity and respiration information is extracted from the sensor data. Next in step 608 risk scores are obtained according to the information type. Next in step 610 total risk score is calculated. And finally in 612 a risk assessment is displayed, for example as high, medium, or low risk.

Activity counts are a global measure of activity level derived from the raw accelerometer data. Variations of information include:

Total activity counts/day (or week)

Average activity count/day (or week)

Peak activity count/day (or week)

Longest sustained activity/day (or week)

Longest period of inactivity (sleep)

In general, patients who have higher activity levels tend to have a lower risk for an exacerbation.

Walking is one of the most common forms of physical activity that patients with COPD are still able to perform. The number of steps walked in a given day or week and the walking speed offers more detailed information regarding their ability to conduct this type of physical activity. Patients who walk a greater number of steps and at a higher pace have a lower risk for hospitalization.

The number of breaks that patients take during walking and the duration of these breaks provide information on the patient's ability to perform physical activity. Patients who take more pauses while walking and for a long period of time are likely to be suffering from severe dyspnea, which one of the prominent indicators of an exacerbation. These patients are therefore are a higher risk for hospitalization.

Patients who are inactive for long periods of time are likely to suffer from a poor health condition and consequently have a higher risk for hospitalization.

Transition times are the time or duration needed to change the type of physical activity. The transition time include, but are not limited to the following:

Time to get out of bed in the morning

Time to go from lying down to sitting

Time to go from sitting to standing

Time to go to bed in the evening

In general, patients who require long transition times for various activities have a poorer health condition and a higher risk for hospitalization.

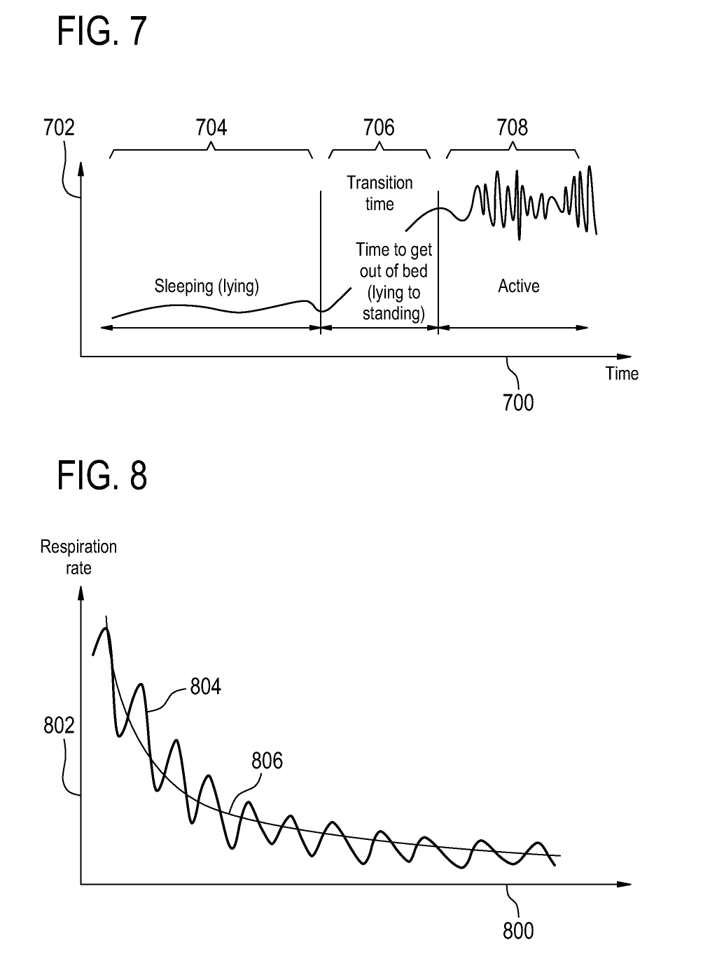

FIG. 7 shows a plot of time 700 versus activity counts 702. The activity counts are divided into three regions; there is a sleeping period 704, a transition period 706, and an active period 708. This FIG. illustrates how the activity counts could be used to determine the sleeping, transition and active period 708. In the sleeping period the activity counts are much lower. In the transition time 706 there is a large change in the activity counts. And finally in the active period 708 there is a larger number of activity counts and the counts are changing dramatically.

FIG. 8 shows a plot of the time versus the respiration rate 802. This illustrates how the respiration recovery rate may be calculated. The curve 804 shows the actual respiration rate 804. The curve 806 is an exponential recovery rate fit 806 to the curve 804. The fit 806 is used to determine the recovery rate.

FIG. 8 illustrates how the respiration rate of a patient recovers when physical activity has been stopped. The shape of the graph will generally be inversely exponential and is determined by the health status of the patient. If the patient is fit and healthy then the respiration rate will return to normal quickly. Patients with poor health condition will require a longer time to achieve normal a normal respiration rate.

The respiration rate after activity is stopped may be expressed as: Resp (tn)=c(t0) exp (−1/τ(tn)). Here tn is the time after relaxation in scale of minutes or seconds, e.g. (300 second after the activity), C(t0) is the constant function of respiration rate at t=0 (stop time) and τ(tn) is the decay time.

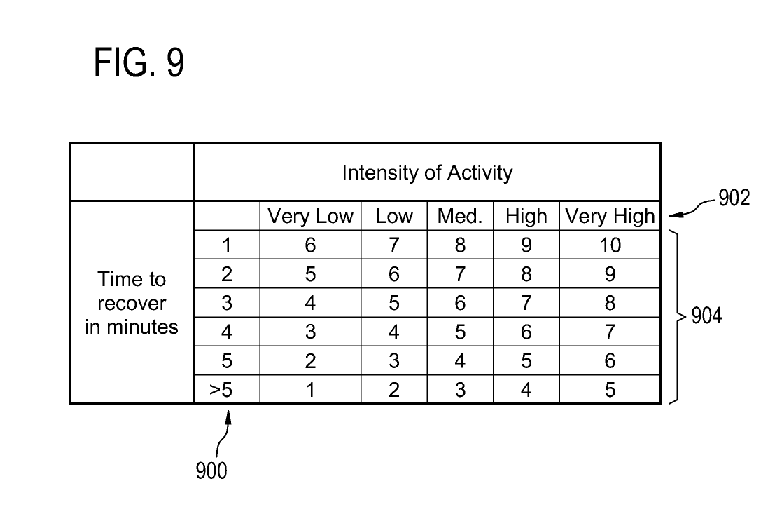

FIG. 9 shows a table which illustrates how a health condition index 904 can be assigned using the recovery time calculated in FIG. 8. The column 900 shows the recovery time in minutes. The row 902 shows the intensity of the activity going from very low to very high. Depending upon the recovery time and the intensity of the activity 902 a health condition index 904 is assigned. The health condition index 904 may be a score in some embodiments.

The table in FIG. 9 shows a health condition factor for a patient. If the patient has a poor health condition, they will take longer to recover from performing a physical task, e.g. a patient is performing a “low intensity” activity and takes 1 minute to recover are assigned a health condition index of “7” and a longer recovery time will result in a lower health condition index. If the patient recovers quickly from a “very high” intensity task then they are fitter and have a higher health condition index. A lower health condition index indicates a poorer health condition of the patient. The recovery time is a measure of how long it takes for the respiration rate to return to baseline after some form of physical activity.

Each type of information is given a score depending on the measurement. Subsequently, a total score is derived to indicate the risk of a patient for being hospitalized. A higher score indicates a higher risk.

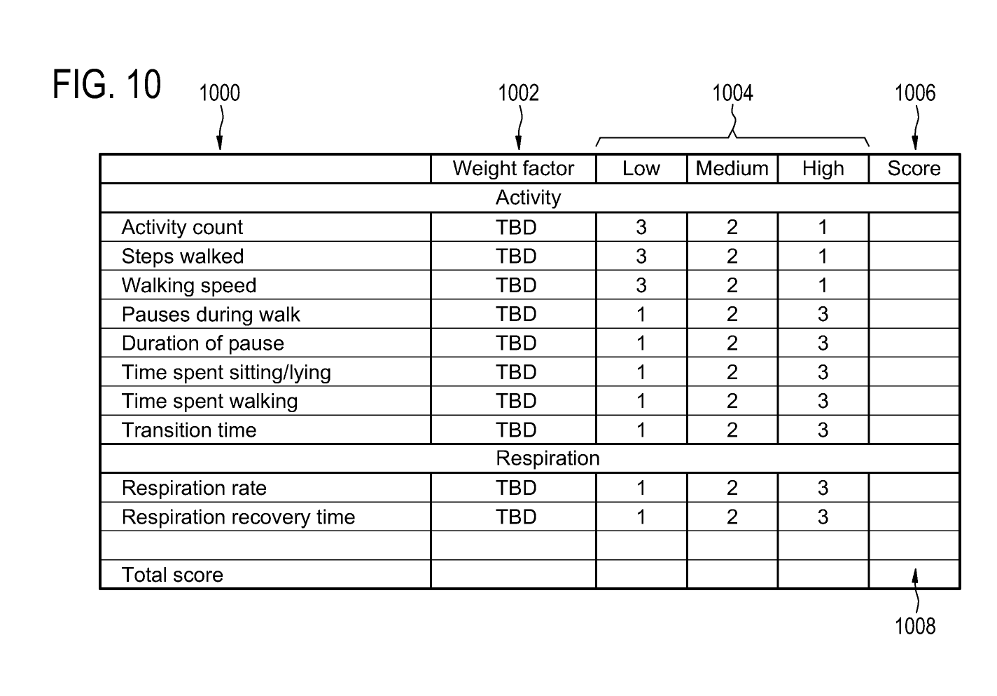

FIG. 10 shows a table which illustrates how to calculate a total risk 1008. This table in the column 1000 there are different statistical parameters. Each of these parameters is given a weighting factor 1002. The columns 1004 indicate the risk score 1004 according to different levels or stratifications of the statistical parameters 1000. Scores 1006 are calculated for each of the statistical parameters 1000. These are then added to calculate a total risk score 1008.

In some embodiments, the system can function in two modes: active and ambient. In active mode, the patient can be asked to perform a certain known physical task and the activity and respiration data is measured before, during and after the activity. In ambient mode, data from the accelerometers is used to deduce the patient activity. These are normal activities that the patient will probably do at some point during a normal day. Logging during the entire day will give an accurate overview of the activities of the patient. Health conditions can then be derived from the intensity and the time it takes the patient to perform these daily activities.

The accelerometers are typically small sensors worn on the chest, belt, and/or pocket. Most activities can be detected using a single accelerometer. If required additional accelerometers can be deployed to deliver greater accuracy. However this will reduce the unobtrusive nature of the monitoring system, increase discomfort and reduce compliance.

In alternative embodiment, additional data such as SpO2, symptom, patient demographics and clinical history data can be integrated to provide a more accurate risk prediction. For example, it is known that patients with a history of hospital readmissions are more likely to be readmitted. Therefore, combining this type of information with real time activity information measured from the patient can provide a very valuable tool.

COPD exacerbations are the worsening of symptoms, e.g. increased coughing, shortness of breath and sputum production, from baseline. They are normally caused by viral or bacterial infections and often lead to hospitalization, which are the largest cost item of COPD. When a patient feels worsening of symptoms, and the upcoming exacerbation, he triggers care or changes his treatment. However patient perspective from changes in symptom is subjective and impaired based on the condition of patient. Early detection of exacerbation based on translation of patient's symptom to objective measures can help with initiating care on time and optimizing the treatment of patient. Consequently this will reduce healthcare costs.

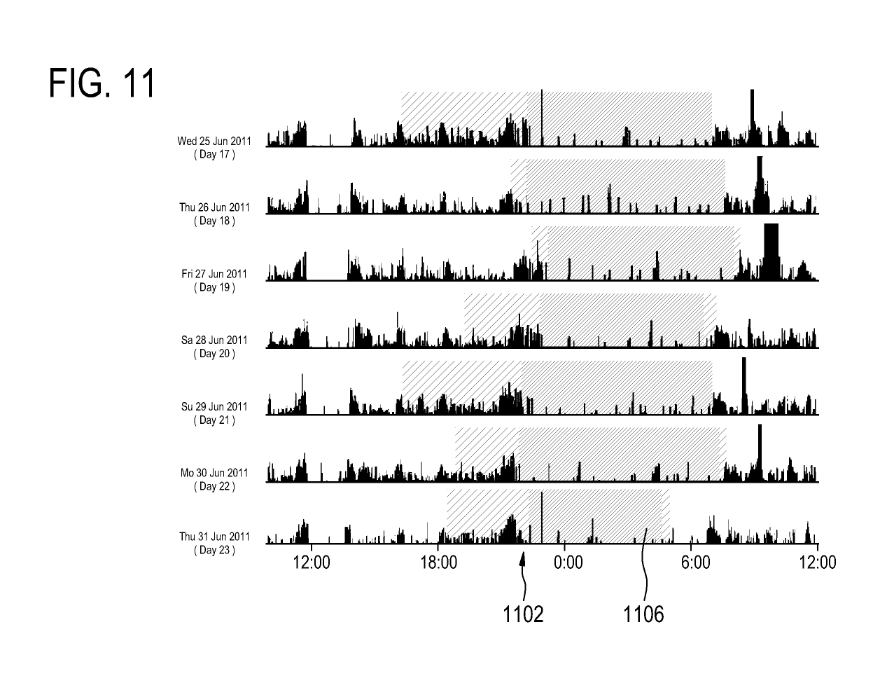

Change of activity is often mentioned as a good measure to detect exacerbations in COPD. But when looking at activity patterns as depicted FIG. 11, it is obvious that there is a need to define measures that can show that change.

FIG. 11 shows an example of activity patterns in COPD patients. Image 1102 shows activity patterns a subject. The shaded region 1106 shows when the subject was sleeping, although in this case the subject was wearing the activity monitor during sleep. FIG. 11 shows that the subject has a regular behavior in going to bed and getting up in the morning, we see also a regular period of inactivity around 15:00 every day. This could be a nap or watching a TV show. When a patient is getting sick he can deviate from this routine behavior. Sleep more, have a more irregular behavior pattern or show more activity during the night. The key of detecting changes in this type of behavior is to define the right parameters that are indicative for these things.

Embodiments of the invention may provide a method of detecting of early exacerbation using activity patterns that are indicative in daily or weekly routine behavior of a COPD patient. Any deviation from normal (baseline) behavior can indicate the patient's condition getting worse. A person who always has routine behavior can get less routine, spending more time in bed etc. It can also be that a person that has no daily routine when he's feeling well. Will behave more structured when he is feeling bad, taking more regular bed rest.

Embodiments may comprise of a set of parameters derived from measured activity signals that are indicative for daily behavior and activities. Change in these parameters itself over time can be an indicative for upcoming exacerbations. And can be used to warn for exacerbation or trigger any medical or non-medical intervention.

These parameters can be used as additional objective measure together with patient reported symptom to detect exacerbation early.

Second based on this parameters a measure for routine can be determined. To this end a template daily pattern is determined based on behavior when the patient is feeling well. This can be done on daily and weekly basis. Then a similarity score can be calculated based on this pattern that is indicative whether the patient is deviating from his normal baseline behavior. This so called behavior similarity score can also be indicative for exacerbations.

In some embodiments, the first step is to calculate a step of parameters that are representative of daily behavior such as:

Total “active” activity count

Intensity level of activity

Longest time of sustained performance activity

Morning rise time and sleeping time

Average activity count in intervals of time (day, evening)

Sleep activity.

### i) Total Day Time Activity Count

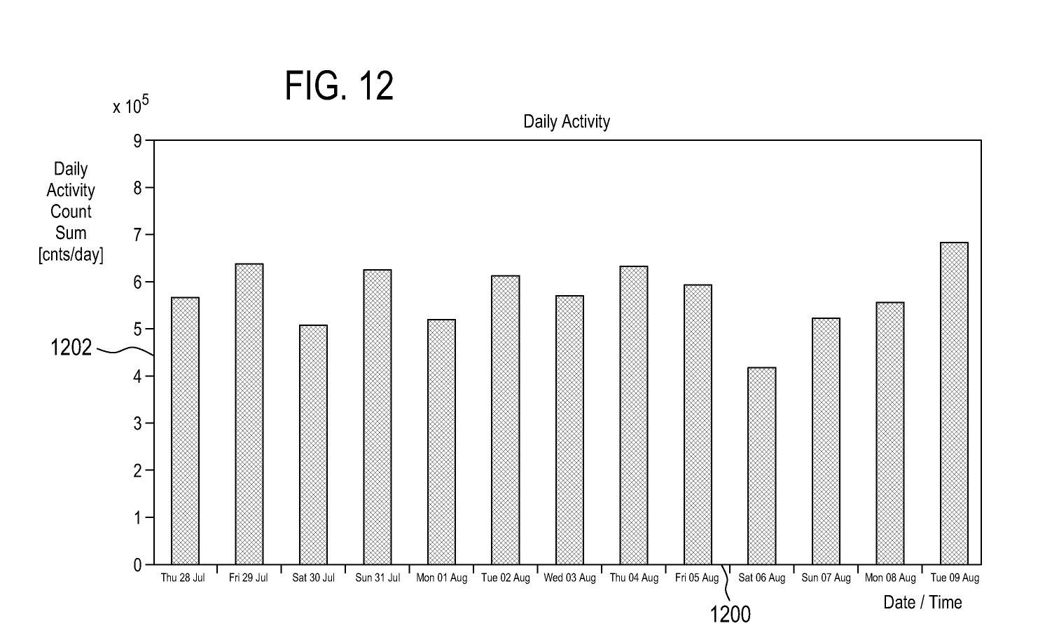

In this invention, the first parameter proposed is to first identify the changes in the total activity count spend on each day during awake period. As usually this figure will be similar when a COPD patient is well. For example, FIG. 12 shows an example of a patient data and it is noticed that on Saturday 6th of August the patient has less activity compare to the other days. It shows that the patient was not well and spent more time resting. Then on the next day on Sunday 7th of August, the patient felt better again and back to normal routine.

FIG. 12 shows the total number of daily activity counts 1202 for different days 1200. In FIG. 12 the total number of activity counts per day is shown.

### ii) Intensity Level of Activity

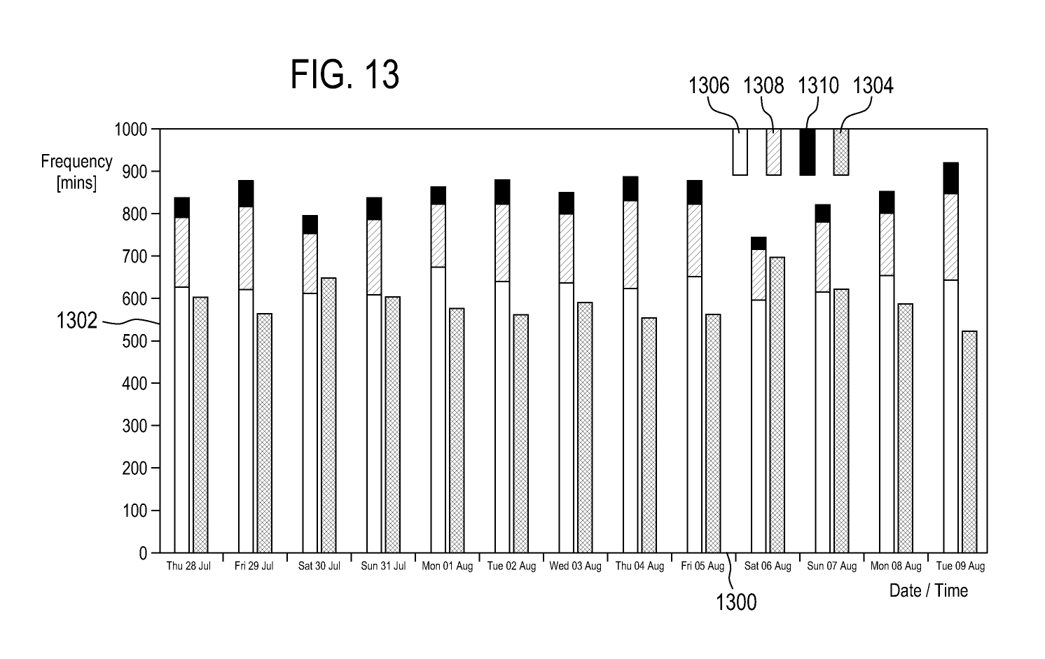

Although the first parameter above can identify the change of behavior based on the activity count, however, it does not provide information on the amount of time the patient spend on different intensity level (Low, Medium and High) of activity. Hence, the second parameter in these invention is to look into the total amount of time spend in a day on different intensity level of activity. FIG. 13 shows clearly the amount of time the patient spends on each intensity level and the change in behavior of the patient from day to day. When the patient is not feeling very well, he or she will be slower in motion and take longer time to do the same type of activity (e.g. making a cup of coffee, waking up from bed, do laundry), so the amount of type spend “LOW” activity will increase whilst “HIGH” activity will decrease.

FIG. 13 shows the same data as shown in FIG. 12 except the activity counts have been broken down differently. In FIG. 13 different days are shown and then the amount of time 1302 spent in different types of activity is shown. The bars labeled 1304 show the amount of time in sleep. The bars labeled 1306 shows the amount of time in low activity. The bars labeled 1308 show the time in medium activity. The time labeled 1310 shows when the individual was highly active.

iii) Longest Time of Sustained Performance Activity

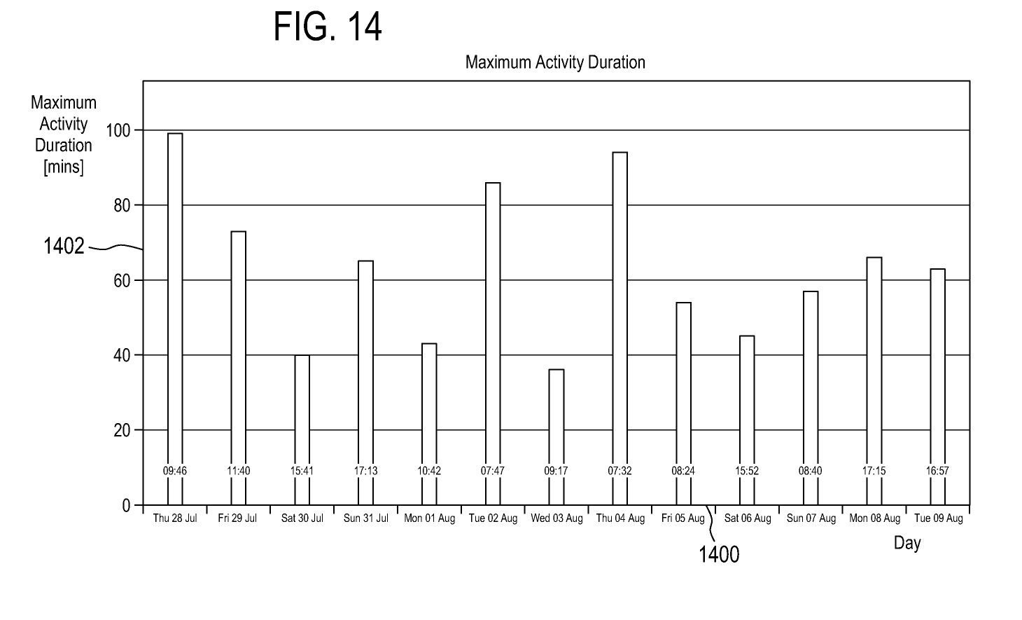

The third parameter proposed in this invention is the longest time of sustained activity per day. It is known that when the health of COPD patient becoming worst, it will become breathless easier. Hence, as a result the patient will have shorter sustained activity. FIG. 4 shows the longest sustained activity for the same patient. Although parameter 1 (Total day time activity count) shows that the patient had the least total activity on Saturday, it didn't mean on the same day the patient will have the shortest sustained activity as shown in FIG. 14.

FIG. 14 shows a plot of the maximum activity duration 1402 for different days 1400. This is an example of another statistical parameter which may be used.

### iv) Morning Rise Time and Sleeping Time

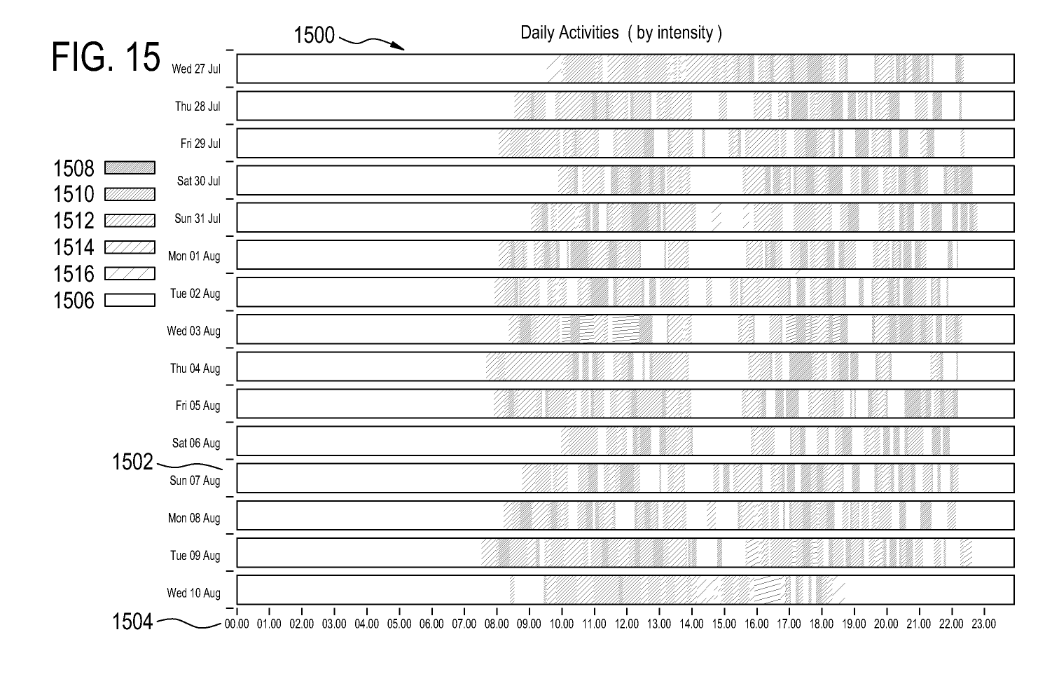

The morning wake up time and night sleep time may be a parameter to indicate the symptoms of COPD patient. This parameter is included in this invention and it can be easily detected from FIG. 5 below. Also, FIG. 15 provides a very useful visualization tool for clinician or patient to understand their daily activity. Any change in the daily activity in FIG. 15 indicates the routine behavior change and it could be easily detected.

FIG. 15 shows an activity diagram 1500 for multiple days 1502. On the x-axis is the time 1504 divided into minutes. The y-axis shows different days 1502. The regions 1506 indicate inactive times of the subject. The regions indicated 1508 are when activity counts are greater than 500 per minute. The regions 1510 are when the subject has activity counts between 500 and 1000 per minute. The regions 1512 are when the subject has activity counts between 1000 and 2000 per minute. The region 1514 is when the subject has activity counts between 2000 and 3000 per minute. The region 1516 is when the activity counts are greater than 3000 per minute.

### v) Average Activity Count in Intervals of Time (Day, Evening)

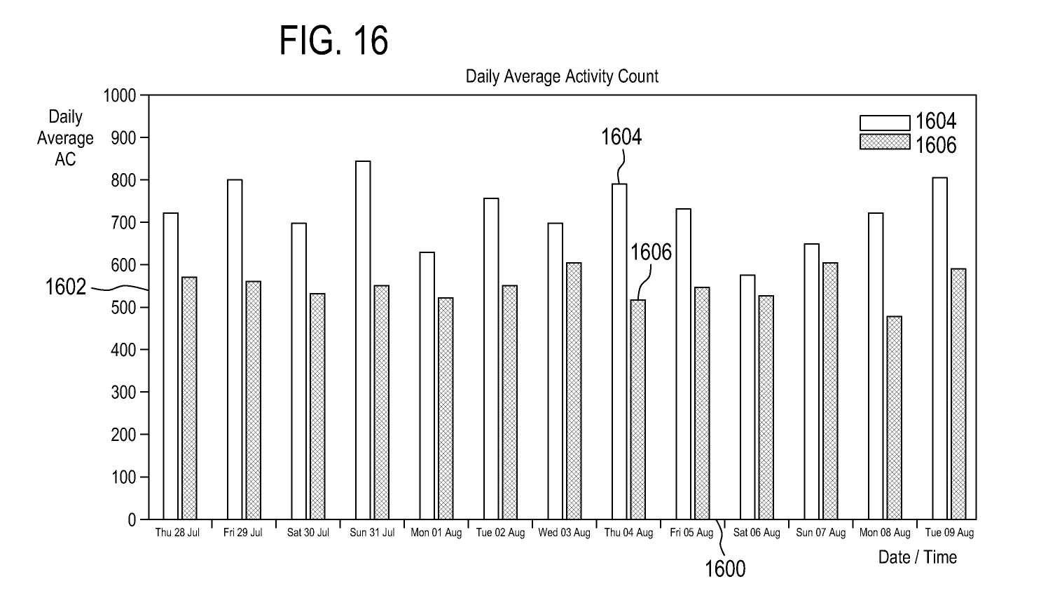

FIG. 16 shows the same data for the average activity count in intervals during the day and the evening. The x-axis shows different days 1600, the y-axis 1602 shows the daily average activity counts. The regions labeled 1604 are during the daytime and the regions labeled 1606 are during the evening.

### vi) Sleep Activity

Sleep problems are common in COPD patients due to symptoms (e.g. difficulty breathing, chronic cough, fatigue and chest tightening) and the medications (which may cause insomnia or daytime sleepiness) used to treat COPD. Also, changes in breathing patterns that occur during normal sleep that do not affect healthy people may actually lead to more severe consequences in COPD patients. Hence, in this invention it is proposed to monitor the sleep activity pattern of COPD patients. Increase in activity during sleeping period could indicate that the symptoms of patient are worsen. Especially is known that patient cough more in the early morning before exacerbation. This cough disturbs their sleep. Changes in sleep activity pattern can detect the onset of exacerbation.

Second based on the parameters above the so called behavioral similarity score is determined. The first step is to see what a patient's stable behavior is.

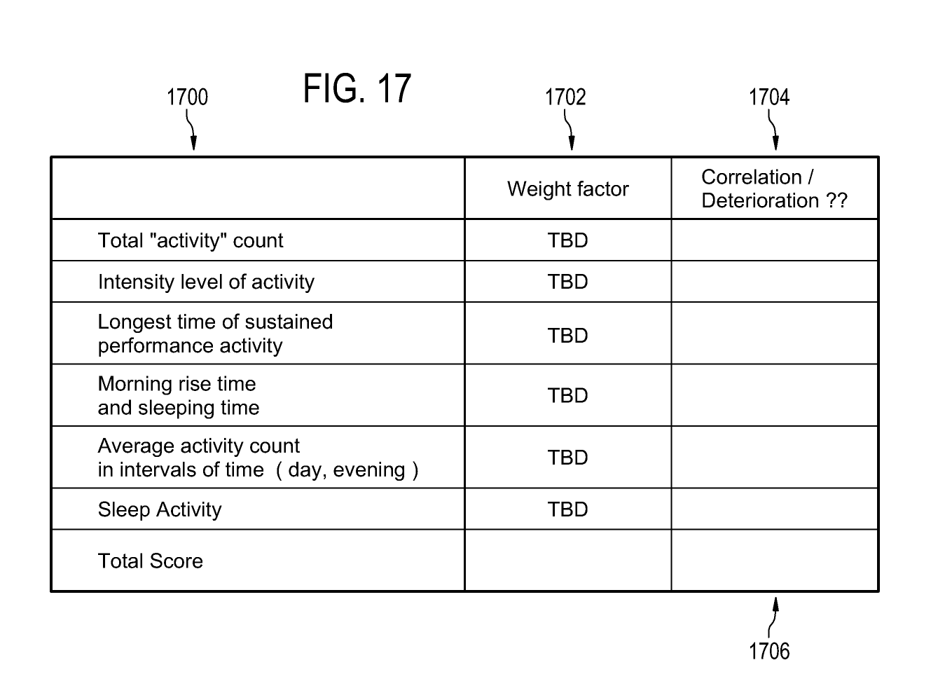

Based on that, a template can be defined for the parameters mentioned above. Then for each new day or week, determine the behavioral similarity score that is calculated based on correlation with the template. An example is shown in FIG. 17.

FIG. 17 shows a table which can be used for calculating the total behavioral similarity score 1706. In column 1700 are listed various behavioral parameters. Column 1702 is a place where weighting factors 1702 can be placed. 1704 shows where individual behavioral similarity scores 1704 can be entered. These are then summed into cell 1706 for calculating the total behavioral similarity score 1706.

It is of great importance for patients suffering from COPD, chronic heart failure or diabetes to be active. A decrease of daily activity can indicate a deterioration of health condition. A measure that is indicative of this deterioration could be the number of steps a patient makes during the day. There are many step detectors available but it is known that they do not perform well during slow walking and slow walking can be a characteristic for this group of patients.

Available step or stride detection algorithms that are published focus on detection of steps or strides, but they only use data from normal walking subjects. Detection of slow steps is a problem.

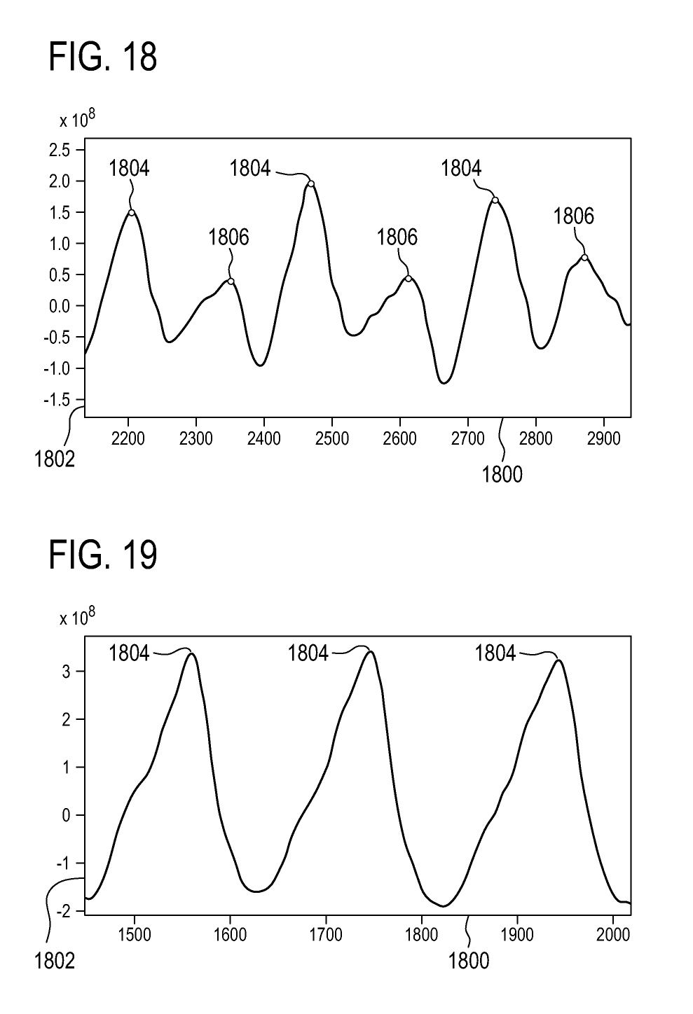

FIG. 18 shows an accelerometer signal acquired by an activity monitor. The x-axis is labeled 1800 and shows time. The y-axis 1802 shows the accelerometer signal 1802. The points labeled 1804 represent a left step and the points labeled 1806 indicate a right step.

FIG. 19 also shows the accelerometer signal acquired by an activity monitor. However, in the example in FIG. 19 only left steps are visible. These two FIGS. illustrate how it may be difficult for a single algorithm to detect if a peak in the accelerometer signal is a full stride or only a half-stride.

FIGS. 18 and 19 shows that in slow walking subjects there different types of signals can be available from an accelerometer worn on the hip:

Both steps present per stride

One step per stride

In-between.

This confuses existing detection algorithms.

The problem of detecting steps in slow walking is that not always all steps of both legs are visible. Sometimes steps are visible, sometimes only from one. And sometimes there's a mix.

One solution is to detect only strides and to discard the steps that come from the other leg. For example, the following solution works by:

Detecting steps with a sensitive peak detector

Detecting steps from ‘other’ leg based on post classification

Discarding these

Outputting: single strides.

Methods according to an embodiment of the invention may have a post classification step that makes the algorithm suitable for detecting slow steps or strides.

Embodiments of an activity monitor according to an embodiment of the invention may have the following features:

1 First step: band-pass filter+peak detector
Constructed in such a way all strides are detected in all subjects (high sensitivity)
False positives are steps from the ‘other leg’: not always present
2 Second step: classification based on 3 features:

Amplitude

Elapsed time from previous step

Estimated walking speed based on the number of peaks detected in 1.

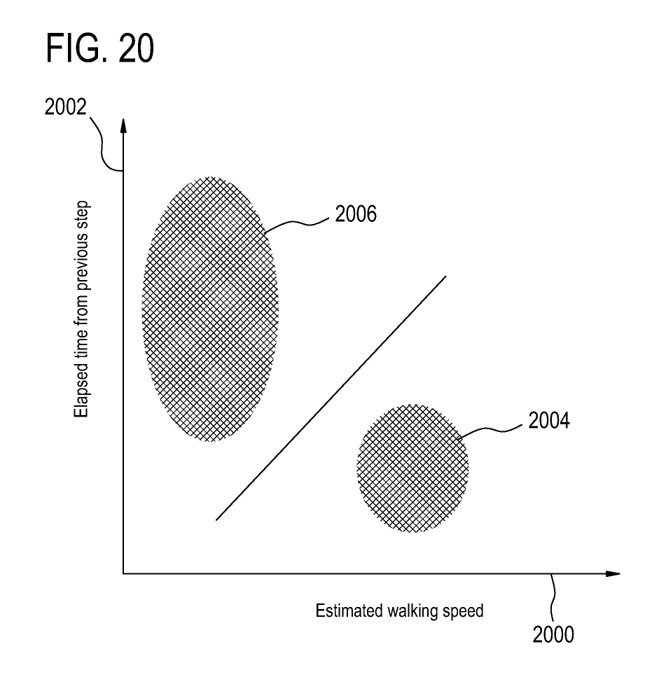

An example of the post classification step is shown in FIG. 20.

FIG. 20 shows an example of how detected steps can be classified. When a step is from the second leg there will be a higher estimated walking speed and a shorter amount of time elapsed from the previous step. Based on these parameters a decision can be made whether the step belongs to an already detected stride. The x-axis shows the estimated walking speed and the y-axis 2002 shows the elapsed time from the previous step. The region 2004 indicates when a detected peak is a half-stride. The region 2006 indicates a region when the detected peak is a full stride.

FIG. 20 shows an Example of post classification of all detected steps. When a step is from the ‘second’ leg, there will be a higher estimated walking speed and a shorter amount of time elapsed from the previous step. Based on these parameters and others a decision can be made whether a step belongs to an already detected stride.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

### LIST OF REFERENCE NUMERALS

400 health monitoring system
402 activity monitor
402′ activity monitor
404 processor
406 memory
408 program
410 activity data
412 sensor
414 subject
416 network connection
418 computer
420 processor
422 computer storage
424 computer memory
426 activity counts
428 statistical parameters
430 risk scores
432 total risk score
434 activity count calculation module
436 statistical parameter calculation module
438 risk score calculation module
440 total risk score calculation module
500 health monitoring system
502 display
504 risk feedback indicators
506 computer
508 processor
510 user interface
512 computer storage
514 computer memory
516 behavioral parameter
518 behavioral similarity score
520 total behavioral similarity score
522 activity count database
524 activity template
526 risk stratification
530 behavioral parameter calculation module
532 behavioral similarity score calculation module
534 total behavioral similarity score calculation module
536 activity count analysis module
538 risk stratification calculation module
540 patient management module
542 graphical user interface
544 risk stratification indication
700 time
702 activity counts
704 sleeping period
706 transition period
708 active period
800 time
802 respiration rate
804 actual respiration rate
806 exponential recovery rate fit
900 recovery time
902 intensity of activity
904 health condition index
1000 statistical parameters
1002 weight factor
1004 risk stratification
1006 score
1008 total score
1100 activity patterns
1102 activity patterns
1104 sleep period
1106 sleep period
1200 day
1202 total activity counts
1300 day
1302 minutes
1304 sleep
1306 low activity
1308 medium activity
1310 high activity
1400 day
1402 duration
1500 activity diagrams
1502 day
1504 time
1506 inactive
1508 activity counts greater than 500 per minute
1510 activity counts between 500 and 1000 per minute
1512 activity counts between 1000 and 2000 per minute
1514 activity counts between 2000 and 3000 per minute
1516 activity counts greater than 3000 per minute
1600 day
1602 daily average activity counts
1604 daytime
1606 evening
1700 behavioral parameter
1702 weighting factor
1704 behavioral similarity score
1706 total behavioral similarity score
1800 time
1802 accelerator signal
1804 left step
1806 right step
2000 walking speed
2002 elapsed time from previous step
2004 half stride
2006 full stride

1. A health monitoring system (400, 500), comprising:
an activity monitor (402, 412, 402′) for acquiring activity data (410) descriptive of the time dependent motion of a subject (414);
a processor (404, 420, 508) for controlling the health monitoring system; and
a memory (406, 424, 514) for storing machine readable instructions (408, 434, 436, 438, 440), wherein execution of the instructions causes the processor to:
derive (208, 306) activity counts (426) from the activity data;
store (102, 210) the activity counts in the memory, wherein each of the activity counts is associated with a time;
calculate (104) at least two statistical parameters (428) from the activity counts, wherein the at least two statistical parameters are descriptive of the activity counts as a function of time;
calculate (106) a risk score (430) for each of the at least two statistical parameters; and
calculate (108) a total risk score (432) using the risk score for each of the at least two statistical parameters.

2. The health monitoring system of claim 1, wherein the activity monitor comprises an accelerometer (412, 602) for measuring accelerometer data, wherein the activity data comprises accelerometer data, wherein execution of the instructions causes the processor to derive the activity counts from the accelerometer data.

3. The health monitoring system of claim 2, wherein execution of the instructions further cause the processor to:
band pass filter (202, 302) the accelerometer data;
identify (204, 304) peaks (1804, 1806) in the band pass filtered accelerometer data; and
classify (206, 306) each of the peaks as either a stride or a half stride in accordance with the peak amplitude to calculate a time dependent walking speed, elapsed time from a previous step, and an estimated walking speed, wherein at least one of the two statistical parameters if descriptive of the time dependent walking speed.

4. The health monitoring system of claim 3, wherein the peaks are classified by comparing the peak amplitude, elapsed time from previous step (2002), and the estimated walking speed (2000) to a predetermined parameter space (2006, 2004).

5. The health monitoring system of claim 1, wherein the activity monitor comprises a respiration sensor (604) for measuring respiration data descriptive of the respiration rate of the subject, wherein the activity data comprises the respiration data, wherein execution of the instructions further causes the processor to:
calculate (606) respiration rate data from the respiration data;
store the respiration rate data in the memory, wherein the respiration rate data is associated with a time;
calculate (608) at least one additional statistical parameter using at least partially the respiration rate data; and
calculate an additional risk score for the at least one additional statistical parameters, wherein the total risk score is calculated (610) at least partially using the additional risk score.

6. The health monitoring system of claim 5, wherein the at least one additional statistical parameter is calculated using at least partially the activity counts to determine a respiration recovery rate (806).

7. The health monitoring system of claim 5, wherein the respiration sensor is any one of: accelerometer, microphone, and a chest expansion sensor.

8. The health monitoring system of claim 1, wherein execution of the instructions further causes the processor to:
calculate at least one behavioral parameter (516, 1700) from the activity counts, wherein the behavioral parameter is descriptive of the activity counts as a function of time; and
calculate a behavioral similarity score (520, 1704) for the at least one behavioral parameter.

9. The health monitoring system of claim 8, wherein the at least one behavioral parameter is any one of the following: a classification of activity intensity according to time of day, the longest period of time where the activity counts are above a predetermined activity, the time of day of the longest period of time where the activity counts are above a predetermined activity, waking time, sleeping time, sleep duration, total activity counts during sleep, the longest period of time where the activity counts are below a predetermined activity, the time of day of the longest period of time where the activity counts are below a predetermined activity, time of longest sustained activity, intensity level of longest sustained activity, duration of longest sustained activity, time of longest sustained inactivity, duration of longest sustained inactivity, average activity counts during different intervals of the day, pauses during walking, duration of pauses, time spent sitting, time spent lying, time spent walking, transition times between activities, and combinations thereof.

10. The health monitoring system of claim 8, wherein execution of the instructions causes the processor to calculate an activity template (524) from archived activity counts, wherein the at least one behavioral parameter is calculated making a comparison of the activity counts to the activity template.

11. The health monitoring system of claim 8, wherein the daily template is calculated by binning and averaging the archived activity counts in a predetermined number of daily time bins, wherein the comparison of the activity counts to the daily activity template is performed by:
binning the activity counts into the daily time bins; and
comparing the number of activity counts in each of the daily time bins to the average number of archived activity counts in each of the daily time bins.

12. The health monitoring system of claim 1, wherein the at least two statistical parameters comprise any one of the following: total activity counts per day, average activity counts per day, the peak activity counts per day, the longest period of activity counts above a predetermined threshold, the longest period of activity counts below a predetermined threshold, an activity transition duration, and combinations thereof.

13. The health monitoring system of claim 1, wherein execution of the instructions further causes the processor to perform any one of the following: display the total risk score on a display, forward the total risk score to a remote patient management system, email the total risk score, and combinations thereof.

14. A computer program product comprising machine executable instructions (408, 434, 436, 438, 440) for execution of a processor (404, 420, 508) of a health monitoring system (400, 500), wherein the health system comprises an activity monitor for acquiring activity data (410) descriptive of the time dependent motion of a subject (414), wherein execution of the instructions causes the processor to:
derive (208, 306) activity counts (426) from the activity data;
store (102, 210) the activity counts in the memory, wherein each of the activity counts is associated with a time;
calculate (104) at least two statistical parameters (428) from the activity counts, wherein the at least two statistical parameters are descriptive of the activity counts as a function of time;
calculate (106) a risk score (430) for each of the at least two statistical parameters; and
calculate (108) a total risk score (432) using the risk score for each of the at least two statistical parameters.

15. A method of health monitoring, the method comprising the steps of:
deriving (208, 306) activity counts (426) from the activity data of an activity monitor, wherein the activity monitor is operable for acquiring activity data descriptive of the time dependent motion of a subject;
recording (102, 210) the activity counts, wherein each of the activity counts is associated with a time;
calculating (104) at least two statistical parameters (428) from the activity counts, wherein the at least two statistical parameters are descriptive of the activity counts as a function of time;
calculating (106) a risk score (430) for each of the at least two statistical parameters; and
calculating (108) a total risk score (432) using the risk score for each of the at least two statistical parameters.

16. The method of claim 15, wherein the method further comprises the step of determining a risk stratification using the total risk score and/or calculating a risk classification for chronic obstructive pulmonary disease exacerbation and/or hospitalizing the subject if the total risk score is within a predetermined range.
